(19) United States
(12) Patent Application Publication
(10) Pub. No.: US 2026/0079784 A1
(43) Pub. Date: Mar. 19, 2026

(54) MONITORING AND DIAGNOSING COMPLEX DISTRIBUTED TECHNICAL SYSTEMS

(71) Applicant: KRAKEN TECHNOLOGIES LIMITED, London (GB)

(72) Inventor: James EDDISON, London (GB)

(73) Assignee: KRAKEN TECHNOLOGIES LIMITED, London (GB)

(21) Appl. No.: 19/106,362

(22) PCT Filed: Jun. 20, 2023
(86) PCT No.: PCT/GB2023/051606

§ 371 Date: Feb. 25, 2025

(30) Foreign Application Priority Data
Aug. 25, 2022 (GB) 2212401.0

(51) Int. Cl. G06F 11/07

(52) U.S. Cl. CPC G06F 11/079; G06F 11/0709

(57) ABSTRACT

Provided is a tool for monitoring a complex technical system having at least one diagnostic user and a plurality of system users, the tool having:

a first diagnostic component for a first diagnostic user, the first diagnostic user component comprising: a first communication interface for selectively communicating with multiple system users and having a filter for sorting communications with individual system users into individual conversation streams, wherein individual communications are assigned time stamps;

a first communication display interface for selectively displaying an individual conversation stream relating to an individual system user as a continuous sequence wherein the first communication interface portion is arranged to update in response to further communication a first parameter display interface for displaying technical system parameters in a first subset of monitored parameters relating to the individual system user's technical configuration status and usage history;

a first parameter configuration interface arranged to permit the first diagnostic user to adjust a first set of adjustable user parameters;

technical event identification logic arranged to identify technical events or changes in parameters in a second subset of monitored parameters relevant to an individual system user's interaction with the system;

event description logic arranged to generate a textual description for each identified technical event;

hybrid conversation logic to insert the generated textual descriptions in sequence into the individual conversation stream based on the technical event time and the timestamps of communications with the individual user.

### FIELD The present invention relates to monitoring and diagnosing faults in complex technical systems, such as utility or communications networks.

### BACKGROUND

Controlling and diagnosing complex distributed systems with multiple users at multiple locations can be problematic and becomes more so when there are multiple human operators and users interacting with complex technical elements. Power networks such as electricity distribution networks, telecommunications networks, in particular access networks for telephony and/or broadband which include subscriber terminations, company-wide intranets and integrated communications systems, manufacturing systems in factories and industrial plant, are just some examples of such complex distributed systems.

Diagnostic systems exist for identifying potential issues in technical components of a system but in complex systems the user interaction with the system may complicate issues. Human users can behave very unpredictably, and “the best laid plans” in terms of system design are not immune to user-generated problems that can be extremely difficult to resolve—not least because many users for many such systems find it difficult to explain the precise nature of the problems that they experience. In real world live systems, a user may interact with numerous portions of a system and more than one diagnostic user may be involved with overlapping interactions and it may be problematic to correlate changes in a system and user experience. In real world systems it is often problematic with existing diagnostic tools to distinguish and correlate technical issues and user issues.

These problems have if anything been exacerbated by the pandemic induced increase in remote or home working. Whereas previously an on-site IT specialist would be on-hand to visit a user experiencing problems with an IT system, meaning that all the details of installation, connection, interaction, and user behaviours could be inspected first hand—and problems replicated, this is now largely a thing of the past. It has long been common for subscribers to telephony and broadband services to complain to their service providers about loss of service, intermittent service, and defective service—and then to complain loudly to friends, family, and on social media, that their service provider won't/can't help, and that the customer service function is hopeless, inconsistent, doesn't listen, etc. Meanwhile, on the supplier's side front line customer-service staff work to extract meaningful information from customers reporting complaints and problems, while generally having little or no visibility of the actual performance and behaviour of the customer's equipment and connection to the supply/network. Frustration can quickly arise on both sides of these interactions, albeit that the front-line staff are doing their best to help, with very limited resources. While some issues can be resolved with a single call (and some good fortune), for many users problems, particularly intermittent problems, may require several interactions. Indeed, some customer service operations are so arranged that only problems that aren't resolved after a few iterations get escalated to engineers, and only then (again possibly after several iterations) may someone from the service provider actually try to look at network behaviours and interactions. By this stage a user may have spoken to several different front-line staff, some or all of whom may have made written notes on a customer service system (CMS), and with any such multi-touch complaint there is likely to be some contradiction between the notes recorded on the CMS—which can obviously be problematic for the next level review (e.g. with the first engineer)—and by this time, many customers can be expected to be annoyed at the lack of progress despite the length of time, and number of calls, spent on trying to get the problem resolved. Particularly intractable problems may involve further interactions with yet more actors on the service provider's side—and each new interaction, and in particular each new actor's involvement, potentially leads to more conflict in the records of what the problem is, when it occurs, what has been done to try to solve it, etc. By this stage, the service provider may be very close to losing a customer (and, thanks to the “reach” of a disgruntled customer's complaints, potentially losing many new customers who might have signed up for service had they not heard about the unhappy customer's problems). But even if the customer is “captive”—e.g. the “customer” is an employee who has to use his employer's network or systems, the loss in productivity can be very significant—and such problems have led a great many employees to leave their jobs.

While it might be thought that the easy solution would be to send an engineer for a site visit, to inspect the network connection(s), equipment, software, etc. and to watch the customer interacting with the network/service/system, such visits are extremely expensive, and few companies have anywhere near enough engineers to support site visits except under the most exceptional circumstances. Moreover, if an engineer does make a site visit, experience shows that there is a good chance that they will have incomplete or inconsistent information—so that they may in effect start from a position of ignorance or worse (the wrong information) as a result of previous multi-touch interactions in respect of the problem—so that sometimes the engineer comes armed to solve a problem that doesn't exist but not to solve the problem that does exist.

There therefore exists a need for improved tools and techniques for monitoring and diagnosing and maintaining complex distributed technical systems, particularly where there is a risk of multi-touch interactions with customers/users.

### SUMMARY

According to a first aspect the invention provides a tool for monitoring a complex technical system having at least one diagnostic user and a plurality of system users, the tool comprising:
a first diagnostic component for a first diagnostic user, the first diagnostic user component comprising:
a first communication interface for selectively communicating with multiple system users and having a filter for sorting communications with individual system users into individual conversation streams, wherein individual communications are assigned time stamps;
a first communication display interface for selectively displaying an individual conversation stream relating to an individual system user as a continuous sequence wherein the first communication interface portion is arranged to update in response to further communication a first parameter display interface for displaying technical system parameters in a first subset of monitored parameters relating to the individual system user's technical configuration status and usage history;
a first parameter configuration interface arranged to permit the first diagnostic user to adjust a first set of adjustable user parameters;
technical event identification logic arranged to identify technical events or changes in parameters in a second subset of monitored parameters relevant to an individual system user's interaction with the system;
event description logic arranged to generate a textual description for each identified technical event;
hybrid conversation logic to insert the generated textual descriptions in sequence into the individual conversation stream based on the technical event time and the timestamps of communications with the individual user.

In this way, while system parameters are displayed for ready access in the parameter interface portion, selected technical events are displayed in sequence with user conversation. This facilitates identification by the diagnostic operator of issues arising from a technical change and correlation of events with user experience issues.

In a development the tool provides a second diagnostic component for a second diagnostic user including: a second communication interface for selectively communicating with multiple system users and having a filter for sorting communications with individual system users into individual conversation streams, wherein individual communications are assigned time stamps;

a second communication display interface for selectively displaying an individual conversation stream relating to an individual system user as a continuous sequence wherein the second communication interface portion is arranged to update in response to further communication;
a second parameter display interface for displaying technical system parameters in a third subset of monitored parameters relating to the individual system user's technical configuration status and usage history;
a second parameter configuration interface arranged to permit the second diagnostic user to adjust a second set of adjustable user parameters; and
wherein at least one of the first and second communication display interfaces is arranged to display communications between an individual system user and both the first and second diagnostic users and said generated textual descriptions in a single conversation stream.

In this way, when multiple diagnostic users operate, usually on different portions of a system, it is possible for at least some diagnostic users to see in a stream multiple diagnostic user interactions with a user as well as events.

The first and second and third subsets of monitored parameters may overlap and may even coincide but need not and may be individually selected.

According to a second aspect there is provided a method comprising:

communicating with a particular system user of a plurality of users of a technical system;
capturing data in respect of each communication with a system user;
applying a timestamp to each communication with a system user;
sorting communications with individual system users into individual conversation streams;
displaying an individual conversation stream relating to an individual system user as a continuous sequence wherein the first communication interface portion is arranged to update in response to further communication;
displaying technical system parameters in a first subset of monitored parameters relating to the particular system user's technical configuration status and usage history;
adjusting a first set of adjustable user parameters for the particular system user;
identify technical events or changes in parameters in a second subset of monitored parameters relevant to an individual system user's interaction with the system;
automatically generating a textual description for each identified technical event and inserting the generated textual descriptions in sequence into the individual conversation stream based on the technical event time and the timestamps of communications with the individual user.

Embodiments of the invention will now be described, by way of example only, with reference to the accompanying Figures, in which:

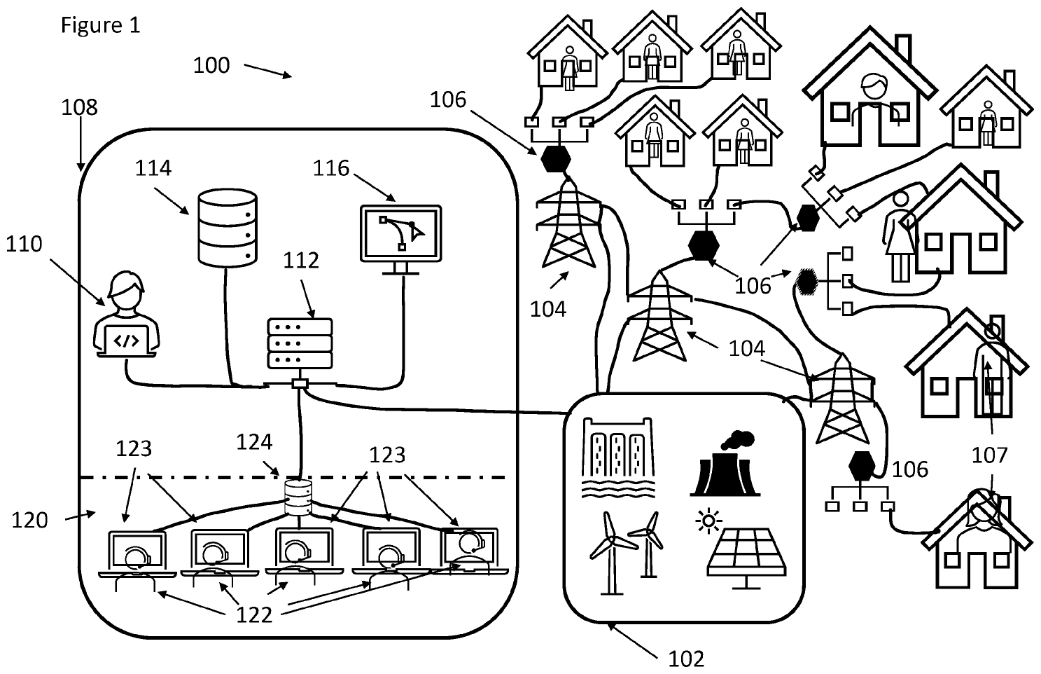

FIG. 1 shows schematically an example of a complex distributed technical system to which embodiments of the invention can be applied;

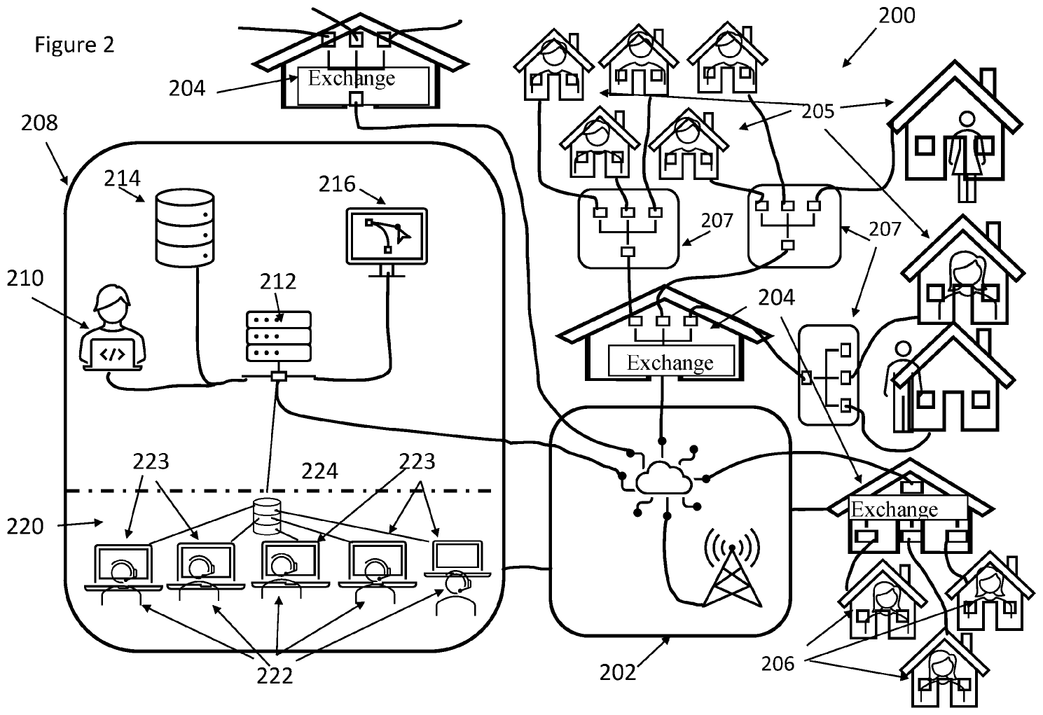

FIG. 2 shows schematically another example of a complex distributed technical system to which embodiments of the invention can be applied;

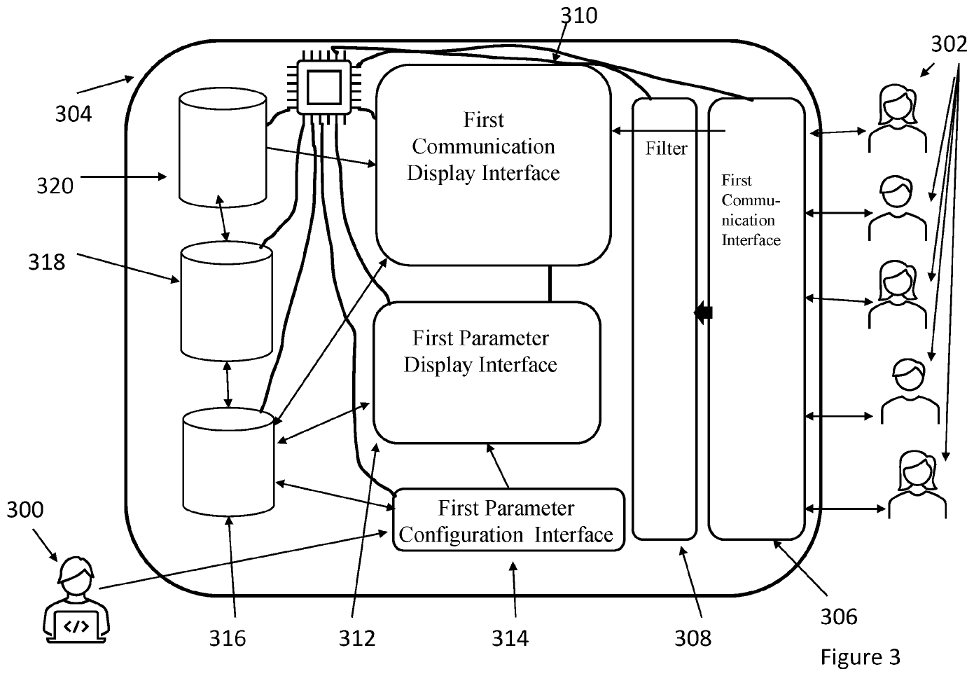

FIG. 3 shows schematically an improved tool, for monitoring complex technical systems, according to an aspect of the invention; and

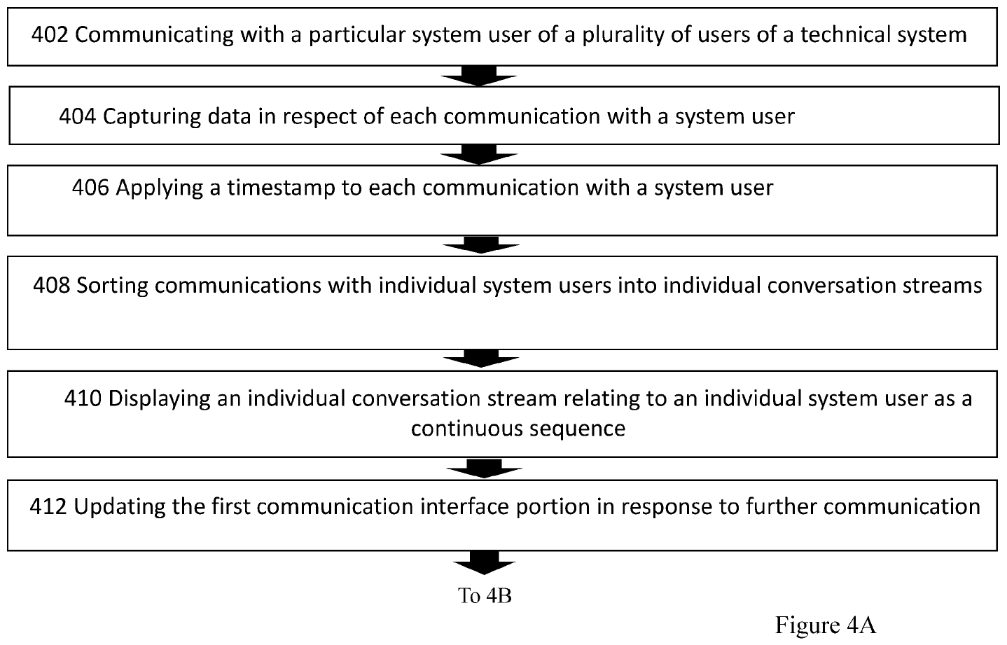

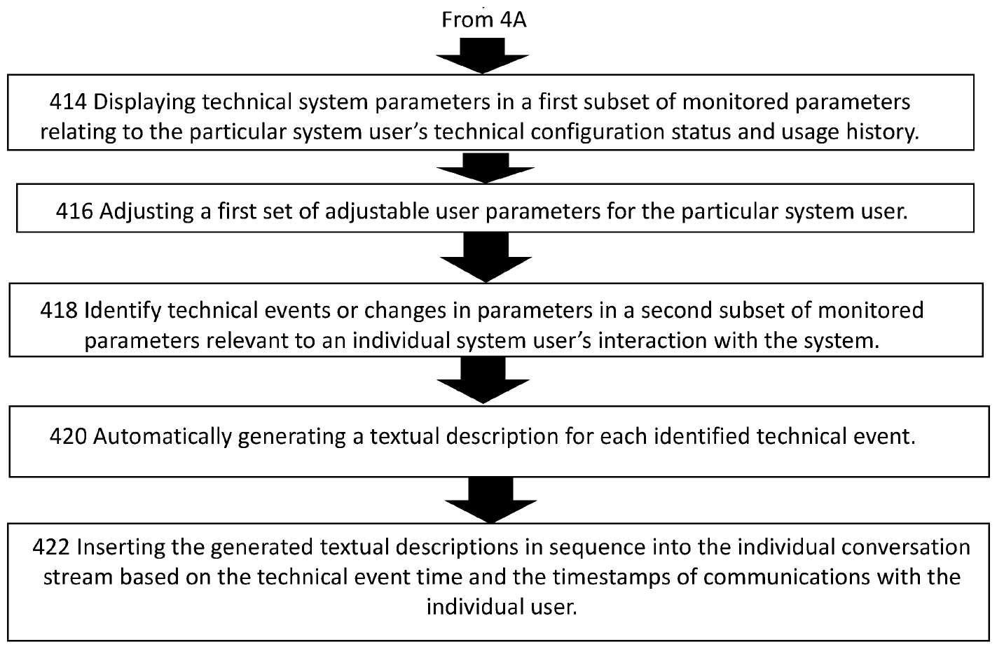

FIG. 4 is a flow chart representing a method according to an aspect of the invention.

### SPECIFIC DESCRIPTION

FIG. 1 shows schematically an example of a complex distributed technical system to which embodiments of the invention can be applied. In this example, the system 100 is in the form of an electrical power supply network. Various power generation installations 102, including wind turbines, solar power, hydroelectric and fossil fuel powered power stations, feed power into a primary electrical distribution network represented by pylons 104. In the UK, voltages of 132 kV, 110 kv, 66 kV, 33 kV and 11 kV are typically used to provide primary distribution, with voltages being stepped down to the medium voltages through the use of transformer stations. Transmission losses tend to be lower at higher voltages, so the aim is to step down to medium voltages and low voltages only as and when required. Electrical substations 106, generally located close to consumers (“system users” in the context of this patent application) 107, are fed by the primary electrical distribution network 104—typically at 11 kV, and are used to provide a 380-415 V three-phase and neutral low voltage supply which is typically further distributed via subterranean cables, typically directly buried in the ground—at least in urban and suburban settings, although sometimes through ducts in the ground. Domestic consumers 107 are typically supplied with electricity over a single-phase circuit at 220-240 V single-phase to neutral derived from a 380-415 V three-phase and neutral low voltage supply.

In rural areas and in less densely populated suburban areas three-phase pole-mounted transformers may be used to supply premises with electricity via aerial cables. In such areas three-phase overhead lines operating at 10-15 kV or 27-33 kV may be supported for many miles on poles. A 380-415 V three-phase supply may be taken from these lines through a small pole-mounted fused input/output transformer. If the maximum load to be taken is below about 50 kW, the supplies for homes or farms may be derived from a single-phase supply operating at 10-15kV. These overhead lines are susceptible to damage from tree branches, wind damage, ice accumulation and lightning strikes, and are consequently generally less reliable than the subterranean cables of urban areas.

The electrical power supply network includes sensors and other monitoring devices to detect voltage (V), frequency (F), current (I), and active (P) and reactive power (Q) at various points (“nodes”) in the network, and generally at transformer stations and substations. All of these parameters need to be controlled and regulated, and so the gathered sensor data are supplied to and monitored by control or monitoring stations 108, typically permanently staffed with human operatives, as indicated at 108.

The monitoring station 108 enables diagnostic system users or engineers 110 (examples of diagnostic users in the context of this patent application) the opportunity to monitor the performance of the electrical distribution network, to see and to respond to alerts and error conditions that are reported based on information received from system sensors and monitoring equipment. The monitoring station 108 includes computer systems 112 that receive data from the sensors and monitoring systems of the electrical distribution network, and that are coupled to a set of one or more databases 114 that store information about the network, network routings, components, and subsystems, and also coupled to system displays 116 which may provide an overview of the electrical distribution network and also flag up incidents—such as failures of links, substations, transformers, fuses, and the like.

Failures may arise due to disturbance of subterranean cables caused by construction projects—such as the digging of foundations or other excavation, lightning strike, equipment failure, floods, fires, etc. Corrective action will often involve despatching engineers and repair crews to make good damage, replace failed components, etc. but may additionally or alternatively involve reconfiguring parts of the distribution network to bypass failed equipment or failed sections of the transmission network. Imbalances of active/reactive power, voltage or frequency errors, etc. may be identified by system alerts and need to be corrected through appropriate system adjustments that may be controlled from the monitoring station 108, or which may require the involvement of other entities such as power generators, suppliers of reactive power services, etc.

The monitoring station, of which there may be more than one for any network operator or service provider, also has access to customer data for each of the system users including details of the location of the customer's premises along with any salient user configuration information, fault records, usage and billing information, etc. These data are held on a relevant database of the set of databases 114.

Also shown in FIG. 1 is a customer service centre 120 which is staffed by human operators 122 who receive telephone calls from, or exchange messages with, system users who wish to register a complaint, order new or updated services, or who have technical or other queries. Although shown schematically as included in the monitoring station 108, generally the customer service centre(s) is/are located remote from the monitoring station(s)—indeed frequently customer service centres are offshored or otherwise located apart from the monitoring stations. The human operators 122 of the customer service centre 120 have access to computer terminals or workstations 123 with which they can access a database 124 of customer account data including usage history, service history, information about products and services to which an individual system user or “customer” has subscribed. Database 124 may be a subset of the set of databases 114, so that the data on database 124 appears as part of the set of databases 114.

The human operators 122 may be the first point of contact for individual system users but sometimes customer access to the operators 122 is via an automated front end which uses speech and digit (e.g. DTMF) recognition and a hierarchy of structured voiced announcements to filter out and deal with those customer queries and issues that can be resolved automatically. Preferably the database 124 also stores data generated as the result of customer interactions with such an automated front end, as well as capturing information about all interactions with the human operators 122.

The human operators are trained to use a structured approach in their interactions with customers, and are generally supported in this by the operation of their computer terminals which in effect guide them through the interaction with the customer—providing prompts in response to operator inputs made as a result of information provided by the customer. Depending upon the skill with which these dialogues or scripts are crafted, they can help to resolve most common customer issues—but if a customer has an unusual issue or one which is not solved by the “standard” response, the same customer may make repeat calls to resolve the same issue but each time receive the same response. The computer system supporting the human operators (sometimes referred to as the CRM system meaning Customer Relationship Management system) is preferably configured to capture the essentials of each interaction that individual system user has with a call centre (and with any automated front end), and the relevant data captured in the CRM database 124. The human operators 122 in the call centre have access to customers'data, so that when an individual system user calls an operator is able to call up that customer's account information which includes details of the services/systems subscribed to, usage and billing history, along with details of previous interactions with the system/service provider—all of which is held on the CRM database 124. But the call centre operators 122 do not generally have access to the same databases as the diagnostic system users or engineers 110 of the monitoring station 108.

Some CRM systems may be designed to flag situations in which the same customer reports the same problem or issue repeatedly, leading to the customer's problem being escalated to a supervisor or to someone else who may be free to work either to a different “script” or possibly without a script at all. But often a customer with a persistent problem will have to make many repeated calls to a call centre before they are put in touch with an engineer or other technically trained individual (a diagnostic system user in the context of the current application) who is likely to be in a better position to help resolve the customer's problem—in part because the majority of customer issues are resolved by a CRM agent or operator 122 following their script.

Some persistent problems can only be resolved on-site, either through a visit to the customer's premises or to some part of the network that serves the customer's premises. But site visits are expensive and “lean staffing” means that typically the number of engineers available at any time is kept to the bare minimum, and it is inefficient to send an engineer out for a site visit to solve a problem if the problem can in fact be solved without such a visit.

FIG. 2 shows schematically another example of a complex distributed technical system to which embodiments of the invention can be applied. In this example, the system 200 is in the form of a telecommunications network, and in particular the “local loop” of such a network that provides broadband to a plurality of system users (“customers”). The network includes a core 202 that provides multiple transmission routes and interconnection between main exchanges (not shown) and local exchanges 204 each of which supports a local loop which provides system users 205/206 with broadband connections, typically either using ADSL (asymmetric digital subscriber line) over the usual twisted pair wiring traditionally used for POTS (here shown as serving users labelled as 205), or over optical fibre (fibre to the premises) here shown as serving users labelled as 206. Commonly, in order to provide high speed broadband access optical fibre is run out from the local exchange 204 to a street cabinet 207 (for fibre to the cabinet), where the optical circuit is terminated to feed a twisted pair connection for the final drop to the premises. Typically each such street cabinet 207 serves tens to a few hundreds of premises, depending upon the housing density (and type), the street cabinet having an electrical power supply to power the optoelectronics that terminate the optical link. A slight variant, known as fibre to the curb, may see the optical fibres terminated and optoelectronic conversion taking place in a footway box (buried in the ground) rather than in an above-ground cabinet. In some cases (for example with village/rural exchanges) customer premises may be connected to the local exchange 204 just via a wired connection, with no intermediate optical link.

For fibre to the premises customers 206 a dedicated optical fibre may be run out to each customer from the local exchange 204, although typically many such individual fibres will terminate at the exchange from a common cable that houses tens or sometimes hundreds of fibres (depending upon the population/housing density), the individual fibres being “broken out” from the common cable (often in groups which are further split down eventually to a single fibre or pair of fibres). Premises that house many individual customers, e.g. apartment blocks, will typically receive a fibre (or multi-fibre) feed from the local exchange 204, with optoelectronic conversion (from fibre to copper—possible co-axial rather than twisted pair) happening at a distribution board in the premises.

Where an optical fibre terminates an optical network unit (ONU) is provided which includes optoelectronics and electronics, interfacing between optical communication on the upstream side and electrical communication on the downstream side. The ONU may be provided with customer premises (e.g. within the customer's home or office), outside the customer's building but on the customer's property (e.g. secured to a wall on the outside of the house), or outside the customer's property—for example mounted on a pole in the street, or in a footway box or in another item of street furniture.

As with the power supply network of FIG. 1, control or monitoring stations are provided for the telecommunications network, although there is often a division between management of the core network—which may be managed from one or two network management centres that take care of the whole network, and monitoring of the local loop(s). Although clearly failure of the core network may impact individual customers, frequently system users'problems stem from issues and failures within the local loop or within their premises (including with the network termination at their premises). The local control centre 208 of FIG. 1 may manage one or multiple local exchanges 204 and associated local loops. Computer systems 212 receive information from monitoring equipment in local exchange(s) and information, alerts and updates from a network management centre for the core network. Engineers or diagnostic users 210 can also interrogate elements and systems within local exchanges 204 and at various points in the local loop. Databases 214 hold customer data detailing connection type, location, usage history, etc, including the identity and location of the customer's local exchange and possibly details about the routing of the customer's circuit from the local exchange 204, the identity and location of cabinets/distribution points serving the customer, etc. System displays may be provided to show network status and in particular to highlight any “incidents”or problems.

Also shown in FIG. 2 is a customer service centre 220 which is staffed by human operators 222 who receive telephone calls from, or exchange messages with, system users who wish to register a complaint, order new or updated services, or who have technical or other queries. Although shown schematically as included in the monitoring station 208, generally the customer service centre(s) is/are located remote from the monitoring station(s)—indeed frequently customer service centres are offshored or otherwise located apart from the monitoring stations. The human operators 222 of the customer service centre 220 have access to computer terminals or workstations 123 with which they can access a database 224 of customer account data including usage history, service history, information about products and services to which an individual system user or “customer” has subscribed. Database 224 may be a subset of the set of databases 214, so that the data on database 224 appears as part of the set of databases 214.

The human operators 222 may be the first point of contact for individual system users but sometimes customer access to the operators 222 is via an automated front end which uses speech and digit (e.g. DTMF) recognition and a hierarchy of structured voiced announcements to filter out and deal with those customer queries and issues that can be resolved automatically. Preferably the database 224 also stores data generated as the result of customer interactions with such an automated front end, as well as capturing information about all interactions with the human operators 222.

As with the customer service centre for the electrical supply network of FIG. 1, some CRM systems may be designed to flag situations in which the same customer reports the same problem or issue repeatedly, leading to the customer's problem being escalated to a supervisor or to someone else who may be free to work either to a different “script” or possibly without a script at all. But often a customer with a persistent problem will have to make many repeated calls to a call centre before they are put in touch with an engineer or other technically trained individual (a diagnostic system user in the context of the current application) who is likely to be in a better position to help resolve the customer's problem in part because the majority of customer issues are resolved by a CRM agent or operator 222 following their script.

Some persistent problems can only be resolved on-site, either through a visit to the customer's premises or to some part of the network that serves the customer's premises. But site visits are expensive and “lean staffing” means that typically the number of engineers available at any time is kept to the bare minimum, and it is inefficient to send an engineer out for a site visit to solve a problem if the problem can in fact be solved without such a visit. With telecommunications services such as broadband (and telephony), the problems that customer's experience and report are frequently a consequence of issues arising within the customer's premises rather that issues with the telecommunications network or with the local loop. But to a customer it can be very difficult, if not impossible, to distinguish between such “internal” and “external” faults—all they know is that they seem to have lost their broadband connection, or its terribly slow, or the like. A carefully crafted CRM script, which leads the customer through one or more sequences of actions, may be able to identify the root cause of the customer's problem (as either internal or external) and possibly remedy it if the problem is an internal one (sometimes through the despatching of a new router or some other piece of equipment if this has been identified as the root cause). But some faults, particularly if they are intermittent, can be harder to diagnose. Sometimes, of course, a customer's problem may actually be caused by a problem or defect in the local loop (at the local exchange, at a distribution point, with the wiring/cabling intermediate the local exchange and the customer's premises, or at their network termination)—but typically the CRM agents and their scripts are unable to identify such issues.

Eventually, there will be an escalation of the customer's problem to a diagnostic system user 210, but by this time the customer may already have had several interactions with CRM agents 222 and, depending upon the severity of the problem or the length of time that it has been endured, may well be thinking of changing service provider—and starting to complain to friends/family, and on social media about their bad customer experience. If the situation is going to end well, it is important that when the customer finally gets to speak to an engineer (diagnostic user) the engineer is fully aware of the history of the customer's problem and their interaction with the CRM team. Unfortunately, as many of us know from bitter experience, under these circumstances it is not uncommon for the engineer to appear to have no knowledge of the customer's problem and their history of their complaint.

In the context of FIG. 2 it will be appreciated that broadband services are provided both by telecommunications companies who run telecommunications networks, and who therefore may eb responsible both for the core network and the local loop, but also by ISPs (internet service providers) who provide services either over someone else's local loop or over their own local loop (e.g. dedicated cabling—typically a fibre or coaxial cable network or some hybrid of the two, occasionally with ADSL over twisted pair for the final drop for some customers) which at some point typically feeds into someone else's core or transport network (but may be passed to the ISP's or someone else's satellite system). Such variations in architecture and commercial model may lead to some changes in the particulars of how an ISP's network is monitored and managed, but the general principle of system users initially interfacing with a CRM function and typically only after some iterations being put in touch with an engineer or other diagnostic user remains the norm. As such, the task of expeditiously managing problems experienced by system users remains a key issue for the companies and enterprises concerned.

Embodiments of the present invention seek to provide improved tools and methods for monitoring complex technical systems, and to enable problems affecting system users to be identified more quickly and efficiently.

Such an improved tool 300 is illustrated schematically in FIG. 3. The tool 300 for monitoring a complex technical system that has at least one diagnostic user 302 and a plurality of system users 304, and comprises a first diagnostic component 305 for a first diagnostic user 302. The first diagnostic user component 305 comprises a first communication interface 306, for selectively communicating with multiple system users 304, having a filter 308 for sorting communications with individual system users 304 into individual conversation streams. The individual communications, which may for example be communications with the customer service centre 120 of the electrical supply network of FIG. 1 or with the customer service centre 220 of the telecommunications network of FIG. 2. Any relevant communications with any automated front end of the CRM system may be included in the conversation streams—a relevant communication being one that can be linked to a system user identity and includes any details of a problem or a complaint. The individual communications are each assigned time stamps to permit a temporal sequence of communications to be constructed for use in the individual conversation streams.

A first communication display interface 310 is provided for selectively displaying an individual conversation stream relating to an individual system user as a continuous sequence. In this way, a diagnostic user can view the individual conversation streams for different individual system users to see the history and development of the conversation.

The first communication interface 310 is arranged to update in response to further communications being made (whether originating with the system user or being directed towards the relevant system user).

A first parameter display interface 312 is provided for displaying technical system parameters in a first subset of monitored parameters relating to the individual system user's technical configuration status and usage history. For example, if the complex technical system is a telecommunications network as illustrated in FIG. 2, the technical configuration status may reveal that the relevant system user has upgraded from an ADSL connection with a first guaranteed minimum bitrate (e. g 30 Mbit/s) to a second guaranteed minimum bitrate (e.g. 70 Mbit/s), and then to a FTTH connection. The user's usage history may include information about data usage—e.g. average/peak amount of data downloaded/uploaded per unit time (hour, day, week, etc.), data rates and durations and incidence of peak data rate usage (e.g. from streaming video, online gaming, etc.). If fair usage limits of any kind apply to a user's technical configuration status (either on an individual basis or as a general condition of service) these limits may also appear as part of the user's technical configuration status.

A first parameter configuration interface 314 is provided to permit the first diagnostic user to adjust a first set of adjustable user parameters—for example in the case of an ISP a download bit rate cap, an upload bitrate cap, a fair usage cap or rate or volume, adjust or remove bandwidth throttling. A telco or ISP diagnostic user (engineer) may be able to adjust settings of customer routers remotely, updating firmware or software, force a reboot, adjust operating parameters of the router. Where a system user has FTTH, a diagnostic user may be able remotely to run diagnostics on the optical network unt (ONU) that includes the optoelectronics that interface between the optical fibre and the customer's data circuits (twisted pair, Ethernet—which can generally be categorised as electrical cabling), and may include a microcontroller or other processor. The ONU may be located within customer premises or may be externally mounted at the customer premises. In other configurations such as fibre to the curb a customer's ONU may be located outside the customer's property—in the street for example, either buried or on a pole for example. Typically in these situations too a diagnostic user may be able to remotely run diagnostics on the ONU, adjust settings, update firmware etc. Similarly, a diagnostic user may be able to remotely interrogate, diagnose and adjust optoelectronics and control circuitry in street cabinets and other nodes of the local loop.

In the case that the complex technical system is an electrical power supply network, a diagnostic user may be able to query or adjust user parameters by interrogating and running diagnostics on a “smart meter” at the customer's premises, adjusting settings of the smart meter. The diagnostic user may also be able to adjust user parameters by interrogating, running diagnostics on, and adjusting network equipment that serves a particular customer.

Technical event identification logic 316 is provided to identify technical events or changes in parameters in a second subset of monitored parameters relevant to an individual system user's interaction with the system. Examples of technical events for the telecommunications may include, interactions between engineers and network installations—such as distribution frames in the local exchange 204, street cabinets/distribution points/nodes 207 etc., such as the installation of a new circuit, connection of a new customer, the fixing of a fault for a (another) system user, as well as interventions or adjustments of user parameters as previously described. It will be appreciated that engineers working on distribution frames in exchanges and on distribution points or nodes (such as street cabinets) within the local loop are faced with the very difficult task of working with a crowded mass of circuit terminations and interfaces, and consequently it is unsurprising that on occasion an engineer attempting to make an intervention on one circuit (affecting a first customer) inadvertently causes a problem for one or more other customers. Also, on occasion an engineer may make an intervention thinking that they are working on a circuit for a first customer, when in fact the circuit on which they are working is that of a different customer. For this reason it is extremely helpful to capture details of these interventions because customer faults are not infrequently the result of an engineer's intervention on network equipment in the local loop.

Where the complex technical system is an electrical power supply network similar problems may arise as the result of engineer interventions, the upgrading and replacement of network equipment, the running of new circuits—for example to serve a new housing or commercial development, the replacing or repair of a substation, etc. By logging and capturing the timings of such interventions it can be possible to identify such as interventions as root causes of problems reported later by system users.

Event description logic 318 is provided to generate a textual description for each identified technical event. For example “street cabinet 892/1 opened 08.55 1 Apr. 2022, new circuit connections provided to 892 2555 and 892 2565”, or “fuses replaced at electrical substation 299/67 at 12.45 1 March 2022”.

It will be appreciated that currently it is not usual for (all) ISPs to be aware of all interactions with components/installations in the local loop—for example, in the UK, much of the local loop is maintained by Openreach, and data on Openreach engineers'work rotas is not shared with ISPs. Likewise with local loop unbundling (LLU) ISPs install their own equipment in the local exchange 204, which interconnects with the Main Distribution Frame(s) (MDF) in the local exchange—an ISP's engineers are generally precluded from working on the MDF but likewise Openreach's engineers do not work on the ISP's equipment. Different countries and telcos have different approaches to LLU, but where workers from multiple organisations interact with the equipment of the local loop it will generally be advantageous to try to capture details of all interventions so that the took according to embodiments of the invention has the most complete view of all possible root causes of system user problems.

Hybrid conversation logic 320 is provided to insert the generated textual descriptions in sequence into the individual conversation stream based on the technical event time and the timestamps of communications with the individual user. In this way there is created a log of interactions and events, including those in which the individual system user participated and those in which the system user was not directly concerned, making it possible for a diagnostic user consulting the log to identify probable causal links and root causes, so that it becomes much easier to rectify both persistent and intermittent faults.

This process also lends itself to being used to train a machine learning algorithm (MLA) provided that the MLA is also exposed to the results of interventions made based on the use of these event logs—in other words, if the MLA is exposed to successful interventions where the identified root cause and remedial action resolved a customer's problem, and also to initially unsuccessful interventions where the initial remedial action did not resolve the problem—and to the (hopefully) eventual successful resolution of the customer problem. In this way an MLA may be created to (at least initially) assist diagnostic users in identifying route causes and remedial actions based on patterns of events.

Of course in many cases the resolution of a customer's problems will involve a site visit—for example to rectify a fault introduced by a previous site visit, but the tool according to aspects of the invention may serve to optimally direct such site visits. For example, if the root cause can be attributed to the opening of street cabinet 892/1 on Apr. 1, 2022, an engineer can be directed there rather than to make a site inspection at the customer's premises (which might otherwise be thought necessary and which would involve having to schedule a suitable time for the customer to be able to receive the engineer).

An enhanced version of the tool 300 of FIG. 3 may further comprise a second diagnostic component for a second diagnostic user and may include a second communication interface for selectively communicating with multiple system users and having a filter for sorting communications with individual system users into individual conversation streams, wherein individual communications are assigned time stamps. A second communication display interface may be provided for selectively displaying an individual conversation stream relating to an individual system user as a continuous sequence, the second communication interface portion being arranged to update in response to further communication. A second parameter display interface may be provided for displaying technical system parameters in a third subset of monitored parameters relating to the individual system user's technical configuration status and usage history. A second parameter configuration interface may be arranged to permit the second diagnostic user to adjust a second set of adjustable user parameters. At least one of the first and second communication display interfaces is preferably arranged to display communications between an individual system user and both the first and second diagnostic users and said generated textual descriptions in a single conversation stream. In this way a supervisory or higher level diagnostic user is enabled to review the actions and results of the involvement of a first diagnostic user—for example in the event that the first diagnostic user was unable to resolve or unable completely to resolve the problem of a system user.

FIG. 4 is a flow chart representing a method 400 according to an aspect of the invention. At step 402 selectively communicating with a particular system user of a plurality of system users. At step 404 we capture data in respect of each communication with a system user. At step 406 a timestamp is applied to each communication with a system user. At step 408 communications with individual system users are sorted into individual conversation streams. At step 410 an individual conversation stream relating to an individual system user is displayed as a continuous sequence. At step 412 the first communication interface portion updated in response to further communication. At step 414 technical system parameters in a first subset of monitored parameters relating to the individual system user's technical configuration status and usage history are displayed. At step 416 a first set of adjustable user parameters is adjusted. At step 418 technical events or changes in parameters in a second subset of monitored parameters relevant to an individual system user's interaction with the system are identified. At step 420 a textual description is automatically generated for each identified technical event. At step 422 the generated textual descriptions are inserted in sequence into the individual conversation stream based on the technical event time and the timestamps of communications with the individual user.

1. A tool for monitoring a complex technical system having at least one diagnostic user and a plurality of system users, the tool comprising:
a first diagnostic component for a first diagnostic user, the first diagnostic user component comprising:
a first communication interface for selectively communicating with multiple system users and having a filter for sorting communications with individual system users into individual conversation streams, wherein individual communications are assigned time stamps;
a first communication display interface for selectively displaying an individual conversation stream relating to an individual system user as a continuous sequence wherein the first communication interface portion—is arranged to update in response to further communication,
a first parameter display interface for displaying technical system parameters in a first subset of monitored parameters relating to the individual system user's technical configuration status and usage history;
a first parameter configuration interface arranged to permit the first diagnostic user to adjust a first set of adjustable user parameters;
technical event identification logic arranged to identify technical events or changes in parameters in a second subset of monitored parameters relevant to an individual system user's interaction with the system each technical event associated with a technical event time;
event description logic arranged to generate a textual description for each identified technical event,
hybrid conversation logic arranged to insert the generated textual descriptions in sequence into the individual conversation stream based on the technical event time and the timestamps of communications with the individual user.

2. A tool according to claim 1 further comprising:
a second diagnostic component for a second diagnostic user including:
a second communication interface for selectively communicating with multiple system users and having a filter for sorting communications with individual system users into individual conversation streams, wherein individual communications are assigned time stamps;
a second communication display interface for selectively displaying an individual conversation stream relating to an individual system user as a continuous sequence wherein the second communication interface portion is arranged to update in response to further communication;
a second parameter display interface for displaying technical system parameters in a third subset of monitored parameters relating to the individual system user's technical configuration status and usage history;
a second parameter configuration interface arranged to permit the second diagnostic user to adjust a second set of adjustable user parameters; and
wherein at least one of the first and second communication display interfaces is arranged to display communications between an individual system user and both the first and second diagnostic users and said generated textual descriptions in a single conversation stream.

3. A tool according to claim 1 wherein the complex system is an energy distribution network, wherein technical system parameters include energy parameters affecting supply to a plurality of system users.

4. A tool according to claim 1 wherein technical system parameters relating to groups of system users are identified.

5. A tool according to claim 4 including logic for correlating interactions with individual system users with technical system parameters associated with the group of users to which each individual system user belongs.

6. A tool according to claim 5 including logic for estimating one or more further affected users or likely level of interactions based on received interactions and affected technical system parameters.

7. A tool according to claim 6 including logic for triggering a pre-emptive message to a system user based on an estimated effect of a change in a technical system parameter.

8. A method comprising:
communicating with a particular system user of a plurality of users of a technical system;
capturing data in respect of each communication with a system user;
applying a timestamp to each communication with a system user;
sorting communications with individual system users into individual conversation streams;
displaying an individual conversation stream relating to an individual system user as a continuous sequence wherein the first communication interface portion is arranged to update in response to further communication;
displaying technical system parameters in a first subset of monitored parameters relating to the particular system user's technical configuration status and usage history;
adjusting a first set of adjustable user parameters for the particular system user;
identifying technical events or changes in parameters in a second subset of monitored parameters relevant to an individual system user's interaction with the system, each technical event associated with a technical event time;
automatically generating a textual description for each identified technical event and
inserting the generated textual descriptions in sequence into the individual conversation stream based on the technical event time and the timestamps of communications with the individual user

9. A tool according to claim 1, wherein the hybrid conversation logic is arranged to:
insert the generated textual descriptions in sequence into the individual conversation stream based on the technical event times and the timestamps of communications with the individual user to generate a time-based diagnostic log combining technical events in time sequence with user communications.

10. A tool according to claim 9, configured to:
output the diagnostic log to facilitate correlation by the first diagnostic user of technical events with user experience issues and/or identification of probable causal links and root causes.

11. A tool according to claim 1, wherein the complex system is an energy distribution network, wherein technical events comprise one or more of: engineer interventions, the upgrading and replacement of network equipment, addition of new circuits, for example to serve a new housing or commercial development, replacing or repair of a substation.

12. A tool according to claim 1, further configured to:
train a machine learning algorithm based on the diagnostic event logs output by the hybrid conversation logic and based on knowledge of successful and unsuccessful interventions made based on the event logs; and
use the trained machine learning algorithm to assist diagnostic users in identifying root causes and remedial actions based on patterns of events.

13. A non-transitory computer-readable medium comprising software code arranged when executed to perform operations implementing a tool as defined in claim 1.

14. A system comprising a tool according to claim 1, wherein the system further comprises a machine learning subsystem comprising:
a training module configured to train a machine learning algorithm (MLA) based on logs created using the tool, the training module configured to expose the MLA to the results of interventions made based on the use of the logs, including:
successful interventions where an identified root cause and remedial action resolved a problem, and
unsuccessful interventions where an initial remedial action did not resolve a problem; and
an inference module configured to enable use of the trained MLA by diagnostic users for identifying root causes and/or remedial actions.
